(19) United States
(12) Patent Application Publication
(10) Pub. No.: US 2026/0231865 A1
(43) Pub. Date: Aug. 13, 2026

(54) ROTOBALER WITH A DENSITY SENSOR

(71) Applicant: KVERNELAND GROUP RAVENNA S.R.L., Russi (Ravenna) (IT)

(72) Inventors: Maurizio VECCHI, Sasso Marconi (Bologna) (IT); Cosimo FRASCELLA, Lugo (RA) (IT)

(21) Appl. No.: 19/474,617

(22) PCT Filed: Apr. 11, 2024
(86) PCT No.: PCT/IB2024/053533

§ 371 Date: Oct. 10, 2025

(30) Foreign Application Priority Data
Apr. 12, 2023 (IT) 102023000006987

(51) Int. Cl. A01F 15/07; A01F 15/08

(52) U.S. Cl. CPC A01F 15/0705; A01F 15/0833; A01F 15/0883

(57) ABSTRACT

A round baler, for forming a bale from crops, comprising: a baling chamber including a first shell and a second shell and movable between a forming configuration and a releasing configuration, wherein the first and the second shell are spaced from each other; a first and a second plurality of rollers associated with the first shell and the second shell, respectively; a releasing actuator, configured for switching the baling chamber between the forming configuration and the releasing configuration; a control unit, for instructing the releasing actuator; a detecting unit, including a rigid contact element, having a contact end and rotatably connected to a frame, for rotating in response to a movement of the first shell or of the second shell, and a sensor, configured for detecting a thrust signal depending on the angular position of the contact element.

### TECHNICAL FIELD

This invention relates to a round baler and a method for making bales using a round baler.

### BACKGROUND ART

In the sector of round balers the use is known of a baling chamber, in which crops are fed which are then pressed into bales for their harvesting. The baling chamber may be fixed or variable in volume but, for the purpose of this invention, it is more common that they are fixed volume chambers.

Amongst the types of prior art round balers, there are the round balers including a first baling chamber and a second baling chamber. The first baling chamber comprises a first shell and a second shell. The first shell and the second shell of the first baling chamber rotate about respective hinges. When the bale has reached a certain density in the first baling chamber, the second shell opens to define an access to the second baling chamber and the first shell rotates to overturn the bale in the second baling chamber. There are also round balers which comprise a single baling chamber (comparable to the second baling chamber introduced above), in which there is a fixed shell and a second shell which is movable to allow the discharging to the ground of the bale.

In the round balers it is very important to determine the exact moment in which to overturn the bale from the first to the second baling chamber or the exact moment in which to discharge the bale to the ground from the second baling chamber. That moment is basically linked to the density of the bale, which, when a certain density value is reached, must be discharged from the baling chamber.

For this purpose, the prior art round balers provide detecting units which allow the density of the bale to be derived. For example, the use of a detecting unit is known which is configured to derive the density on the basis of a compliance of the first shell, due to a thrust and a weight of the bale being formed. The detecting unit is illustrated in document EP3058806B1. The document illustrates a solution wherein a distance sensor is positioned directly towards the first shell to derive a distance value which is proportional to an angle of rotation of the first shell. This solution has several drawbacks in terms of reliability, at least due to the dirt which accumulates beneath the first shell. Another example of balers with detection of data on bale density is disclosed in patent document WO2022/024102A1. This document discloses a baler having a chassis which includes a first part and a second part; wherein the second part moves between a closed position, to allow the bale formation inside the baling chamber, and an open position, to allow the bale release from the balling chamber. The solution of WO2022/024102A1 provides a pair of retaining devices which are used to retain second shell of the baling chamber in the closed state against the pressure exerted by the bale during bale formation, and a pair of load sensors are placed in proximity to the retaining devices to detect signals indicative of the forces induced in the respective retaining devices by the pressure being applied to a bale being formed in the balling chamber. According to the solution of this document, a microprocessor reads signals from the load sensors and determines the uniformity or non-uniformity of the density of the bale across the axial length thereof from the signals read from the load sensors and certain actions are taken correspondingly.

Moreover, a pair of latches are provided, which are configured to rotate in response to a movement of the second shell. In particular, the latches and respective receivers are configured to keep the chamber closed during baling through an engagement therebetween, and to disengage to allow opening of the chamber at the end of baling, therefore, the luchtes are configured to pivot to be engaged to/disengaged from the receivers in response to the movement of the second shell of the baling chamber. In particular, the latches are provided with the purpose of retaining the first and the second part of the housing in the closed state against the pressure being applied to the bale as the bale is being formed.

### AIM OF THE INVENTION

The aim of this invention is to provide a round baler and a method for making bales which overcome the above-mentioned disadvantages of the prior art.

Said aim is fully achieved by the round baler and by the method according to the invention as characterised in the appended claims.

According to an aspect of the invention, the invention provides a round baler.

The round baler comprises a frame.

The round baler comprises a baling chamber. The baling chamber is associated with the frame. The baling chamber is configured for forming, at least partly, a bale starting from crops.

The baling chamber comprises a first shell and a second shell.

The baling chamber is movable between a forming configuration, wherein the first and the second shell are closed to each other to define an inner space (preferably fixed) in which the crops are fed, and a releasing configuration, wherein the first and the second shell are spaced from each other to allow an escape of the bale from the baling chamber. The expression “escape of the bale” is used to mean both the transferring of the bales to a further baling chamber, as in the case of round balers known in the trade as a non-stop balers, and the discharging of the bales directly to the ground.

The first shell and/or the second shell, in the forming configuration of the baling chamber, are able to yield relative to the frame by the effect of a thrust exerted by the bale being formed.

In particular, according to an embodiment, for example in the case of the non-stop baler, the first shell is compliant. On the other hand, in the cases where the baling chamber is the chamber which precedes the discharging of the bale, it is the second shell (that is, the door) which is compliant.

According to an embodiment, the round baler comprises a first and a second plurality of rollers associated with the first shell and with the second shell, respectively, for moving the crops inside the baling chamber. The round baler comprises a releasing actuator, configured for switching the baling chamber between the forming configuration and the releasing configuration. The round baler comprises a control unit, configured for instructing the releasing actuator in switching the baling chamber.

The round baler comprises a detecting unit. The detecting unit is configured for detecting a thrust signal. The thrust signal represents a pressure of the bale in the baling chamber. The detecting unit is configured for sending the thrust signal to the control unit.

Preferably, the control unit is configured for controlling the releasing actuator to switch the baling chamber to the releasing position on the basis of the thrust signal.

The detecting unit comprises a contact element. The contact element is preferably rigid. The contact element comprises a contact end. The contact element is configured to remain in contact with the first shell or the second shell in the forming configuration of the baling chamber. The contact element is rotatably connected to the frame, to rotate in response to a movement of the first shell or of the second shell.

The detecting unit comprises a sensor. The sensor is configured for detecting the thrust signal. The thrust signal represents an angular position of the contact element.

The use of this solution increases the reliability of the system, since it allows the detection of the compliance in an element different from the shell, in a zone more covered and not affected by dirt or residues of crops. The detecting unit comprises a connection element which is configured to keep the contact element in constant contact with the first or the second shell, when the baling chamber is in the baling configuration.

The connection element may have different configurations. For example, in one example, the connection element is an elastic element. However, other solutions, in addition to the elastic element, may be adopted to keep the contact end of the contact element in constant contact with the shell.

According to an embodiment, the sensor is a distance sensor. The distance sensor is configured for detecting an operating distance. The operating distance represents a distance of the sensor from a detection portion of the contact element. The detecting unit is made in such a way that a rotation of the contact element causes a corresponding variation of the operating distance.

The distance sensor is simple, reliable and inexpensive, so it is a very practical and convenient solution.

According to other embodiments, the sensor is a load cell, which determines, for example, the elastic force on a spring or the pulling force on a deformation element, which is proportional to the rotation of the contact element.

Lastly, as a further embodiment, there may be an angular sensor (for example an encoder) configured to detect an angular position of the contact element, which is directly correlated with the density of the bale. This solution has the advantage of having a direct control of the angular position, further simplifying the contact element.

The sensor comprises a hinge, about which the contact element oscillates. According to an embodiment, the detection portion is positioned, relative to the hinge, on the opposite side of the contact end, to define a detection end of the contact element.

This allows the sensor to be located on the opposite side of the first or second shell relative to the first hinge, where there is more space and there is less probability of finding residue of crops.

According to an embodiment, the distance between the contact end and the hinge is greater than the distance between the detecting end and the hinge. This makes it possible to keep the space dedicated to the detection as small as possible and therefore to have a compact sensor.

However, according to other embodiments it is possible that the detection portion is positioned along the contact element, in an intermediate portion between the contact end and the hinge.

According to an embodiment, the detecting unit comprises a cover. The cover includes an opening passed through by the contact element. The detection portion and/or the sensor are covered by the cover.

The presence of the cover minimises the possibility that the detection portion and the sensor are influenced by the presence of undesired material which may affect the density detection.

According to an embodiment, the detecting unit comprises an elastic element. The elastic element includes a first end, connected to the frame, and a second end, connected to the contact element. The elastic element is configured to apply a contact force on the contact element, which keeps the contact end in contact with the second shell.

This allows the contact element to be always kept pressed against the first shell or the second shell, in such a way that there is a precise correspondence between the movement of the first or second shell and the rotation of the contact element. Moreover, according to one aspect of the invention, the detecting unit comprises a rolling element. The rolling element (that is, the bearing) is positioned at the contact end. The rolling element is configured to rotate along a sliding surface of the second shell whilst the contact element rotates about the hinge.

Preferably, this invention relates to the round balers which comprise an additional baling chamber, defining a second baling chamber. In that case, the baling chamber defines a first baling chamber. The second baling chamber is configured to receive the bale from the first baling chamber. According to this embodiment, the second shell is movable about a second hinge to define an access to the second baling chamber from the first baling chamber. Moreover, the first shell is movable about a first hinge for overturning the bale from the first baling chamber to the second baling chamber through said access. The detecting unit is preferably associated with the first shell of the first baling chamber. However, it is possible that there might be a solution wherein the detecting unit is positioned on the second shell.

The fact of positioning it on the first shell is convenient because, also due to the weight of the bale, the compliance of the first shell is greater and the reaching of a certain density value of the bale is more appreciable. In any case, the two solutions can both be applied taking into consideration that, during calibration of the sensor, it is also important to take into consideration the thrust exerted by the bale due to the effect of its weight as well as its size relative to the fixed inner space of the baling chamber.

According to an aspect of the invention, the control unit is configured for accessing configuration data. The configuration data represent one or more of the following characteristics: a type of crop; a humidity value of the crop; a predetermined density value, after reaching which the control unit commands a switching of the baling chamber to the releasing configuration; a predetermined threshold value, representing a value of the thrust signal after reaching which the control unit commands a switching of the baling chamber to the releasing configuration.

According to an embodiment, the control unit is programmed for switching the baling chamber to the releasing configuration on the basis of the configuration data.

In particular, there are various operating modes which can be actuated, in combination or alternatively.

According to a first operating mode (which could be defined as automatic), the control unit is programmed for:
processing the humidity value of the crop inserted with the configuration data;
determining, based on the humidity value of the crop, a predetermined threshold value for the thrust signal, such that the density at which the baling chamber switches to the releasing configuration is equal to a predetermined average density value (value which the control unit has, for example, saved in a memory).

This mode is simple but very effective, since it prevents human errors for setting density which is not suitable for the operations but allows the variability due to the humidity of the material to be taken into consideration, which, in general, is the most significant parameter for the variation in the specific weight of the crop.

It is also possible to provide a solution wherein the control unit is programmed for:
processing the humidity value of the crop and the predetermined density value entered with the configuration data;
determining, based on the humidity value of the crop and the predetermined density value, a predetermined threshold value for the thrust signal, such that the density at which the baling chamber switches to the releasing configuration is equal to the predetermined density value entered by the user.

This type of control is without doubt the best performing control, since it allows a high flexibility for the operator with regard to the choice of density and it takes it into account, also taking into consideration the humidity. Lastly, according to a second operating mode (which could be defined as manual), the control unit is programmed for:
processing the predetermined threshold value entered with the configuration data;
switching, on the basis of the predetermined threshold value inserted, the baling chamber to the releasing configuration when the thrust signal reaches the predetermined threshold value.

This solution allows the operator to intervene directly on the final control parameter, so it makes the control more streamlined and at the total discretion of the operator.

According to an embodiment, the sensor is configured for continuously detect the thrust signal. The control unit is thus configured to continuously derive a density value of the bale.

The control unit is configured for switching the baling chamber to the releasing configuration for a density value of the bale equal to or greater than a predetermined density value.

The continuous detection of the thrust signal, with the consequent continuous derivation of the density, allows a greater flexibility on the materials which can be collected.

In effect, on the basis of the configuration data, the rotation (compliance) which the first shell must undergo in order to reach a certain density is a function of the material being collected. Thus, the thrust signal which determines a release of the bale will have a value which varies on the basis of the material.

In other words, in the example of the distance sensor, the distance detected by the sensor which determines a transfer of the bale from the first baling chamber to the second baling chamber is variable with the variation of the material. If there were no continuous detection of the thrust signal, but only a reaching of a first and a second value of the thrust signal (for example by a contact sensor), the bale could not be used for different types of materials because the second value of the thrust signal would result in different bale densities for different materials.

According to an embodiment, the round baler comprises a user interface. The user interface comprises a screen. The control unit is configured for sending density data to the user interface, to display on the screen (preferably in real time) a density value of the bale. This allows the operator to manually operate the releasing actuator, to transfer the bale into the second baling chamber or to release it to the ground. For example, if the operator realises that the soil is very moist and heavy, it might be decided to release the bale earlier. Alternatively, the user interface is also configured to receive settings data from the operator, representing the predetermined density value which the control unit must use to automatically determine when to release the bale.

According to an aspect of the invention, the invention provides a method for making bales by means of a round baler.

The method comprises a step of forming a bale from crops by means of a baling chamber comprising a first shell and a second shell.

The method comprises a step for moving the crops in the baling chamber, by means of a first and a second plurality of rollers associated with the first shell and the second shell, respectively.

The method comprises a step of moving the baling chamber between a forming configuration, wherein the first and the second shells are closed to each other to define an inner space (preferably fixed) in which the crops are fed, and a releasing configuration, wherein the first and the second shell are spaced from each other to allow an escape of the bale from the baling chamber.

The method comprises a step of moving the first and/or the second shell, in the forming configuration of the baling chamber, by the effect of a thrust applied by the bale being formed.

The method comprises a step of detecting a thrust signal, representing a pressure of the bale in the baling chamber, by means of a detecting unit.

The method comprises a step of sending the thrust signal to a control unit. The method comprises a step of controlling a releasing actuator to move the baling chamber in the releasing configuration on the basis of the weight signal, using the control unit.

According to an advantageous aspect of the method, the detecting step comprises a step of rotating a contact element (preferably rigid) in response to a movement of the first shell or of the second shell. The contact element includes a contact end which remains in contact with the first shell or the second shell during a movement of the first shell or of the second shell in the forming configuration of the baling chamber. In other words, the contact end remains in contact with the first or the second shell whilst the first or the second shell yield (and therefore rotate) due to the effect of the thrust of the bale being formed (thus, whilst the baling chamber is in the forming configuration). The thrust signal is detected by a sensor of the detecting unit and represents an angular position of the contact element.

According to an embodiment, the detection step comprises a step of detecting an operating distance, representing a distance of the sensor from a detection portion of the contact element. In effect, the rotation of the contact element causes a corresponding variation of the operating distance.

According to an embodiment of the method, the detection step comprises detecting an angular position of the contact element, which is directly correlated with the density of the bale, by means of an angular sensor (for example, an encoder).

This solution has the advantage of having a direct control of the angular position, further simplifying the contact element.

According to an embodiment, the method comprises a protection step. In the protective step, a cover is positioned to protect the detection portion and/or the sensor.

According to an embodiment, the method comprises an elastic return step. In the elastic return step, an elastic element of the detecting unit applies a contact force on the contact element, which keeps the contact end in contact with the second shell.

According to an embodiment, the method comprises a rolling step. In the rolling step, a rolling element of the detecting unit, positioned at the contact end, rotates along a sliding surface of the second shell whilst the contact element rotates about the hinge.

Preferably, the method comprises a step of transferring the bale from the baling chamber to an additional baling chamber, defining a second baling chamber. In that case, the baling chamber defines a first baling chamber. On the other hand, according to other embodiments of the method, the method comprises a step of discharging the bale from the baling chamber directly to the ground.

According to an aspect of this description, the method comprises a step of access, by the control unit, to configuration data, representing one or more of the following characteristics: a type of crop; a humidity value of the crop; a predetermined density value, after reaching which the control unit commands a switching of the baling chamber to the releasing configuration; a predetermined threshold value, representing a value of the thrust signal after reaching which the control unit commands a switching of the baling chamber to the releasing configuration.

According to an embodiment, the method comprises a control step wherein the control unit switches the baling chamber to the releasing configuration on the basis of the configuration data.

More specifically, the following are some examples of possible operating modes for performing said control step, which may be adopted in combination with, or alternatively to, each other.

According to a first operating mode (which could be defined as automatic), the control unit performs the following steps:
receiving and processing configuration data, representing a humidity value of the crop (for example, the user, using a selector, may set a value for example from 1 to 5-indicating the humidity level of the products to be treated);
determining, on the basis of configuration data indicating the humidity value of the crop, a predetermined threshold value for the thrust signal, such that the density at which the baling chamber switches to the releasing configuration is equal to a predetermined average density value (a value which the control unit has, for example, saved in a memory).

According to a possible variant, the control unit performs the following steps:
processing configuration data indicating the humidity level of the crop and the predetermined density value set by the user;
determining, on the basis of the configuration data, a predetermined threshold value for the thrust signal, such that the density at which the baling chamber switches to the releasing configuration is equal to the predetermined density value entered by the user and such as to take into account the humidity level.

According to a second operating mode (which could be defined as manual), the control unit performs the following steps:
processing the predetermined threshold value entered with the configuration data;
switching, on the basis of the predetermined threshold value inserted, the baling chamber to the releasing configuration when the thrust signal reaches the predetermined threshold value.

According to an embodiment, the detection step is a step of continuously detecting the thrust signal. The control unit thus continuously derives a density value of the bale.

The control unit switches the baling chamber to the releasing configuration for a density value of the bale equal to or greater than a predetermined density value.

According to an embodiment, the method comprises a step of providing, on a screen of a user interface of the round baler, density data, representing a density value of the bale. According to an embodiment, the user interface receives settings data from the operator, representing the predetermined density value which the control unit must use to automatically determine when to release the bale.

### BRIEF DESCRIPTION OF THE DRAWINGS

This and other features will become more apparent from the following description of a preferred embodiment of the invention, illustrated by way of non-limiting example in the accompanying tables of drawings, in which:

FIGS. 1A and 1B illustrate, respectively, a first embodiment of a round baler in a first configuration and in a second configuration;

FIGS. 2A and 2B illustrate, respectively, a second embodiment of a round baler in a first configuration and in a second configuration;

FIG. 3 illustrates a detecting unit of the round baler according to FIG. 1 or FIG. 2.

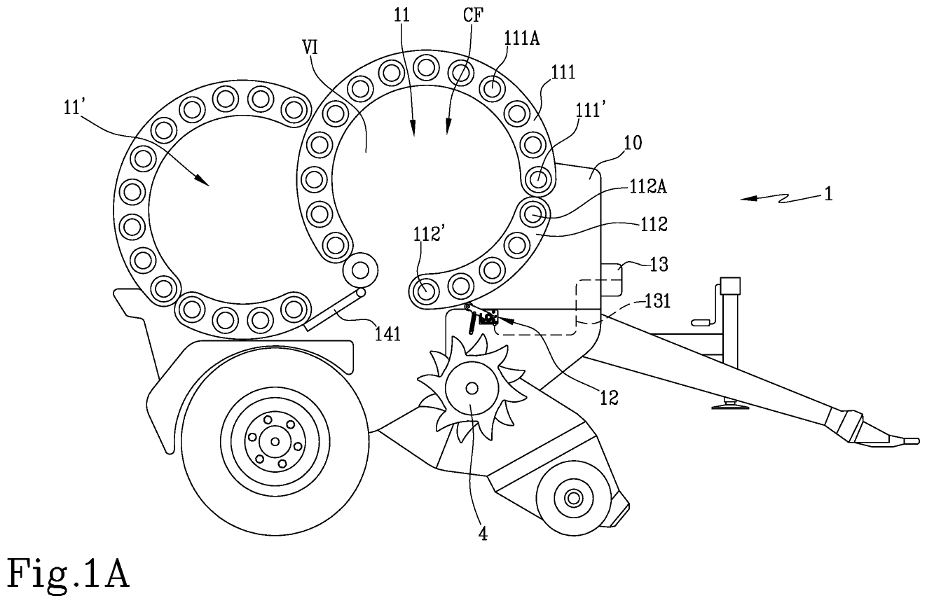

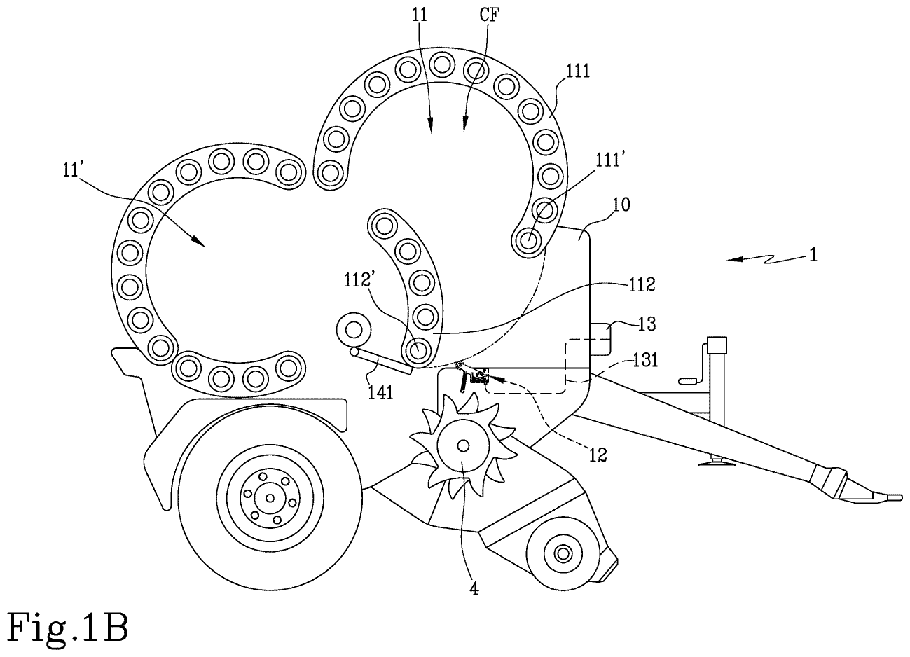

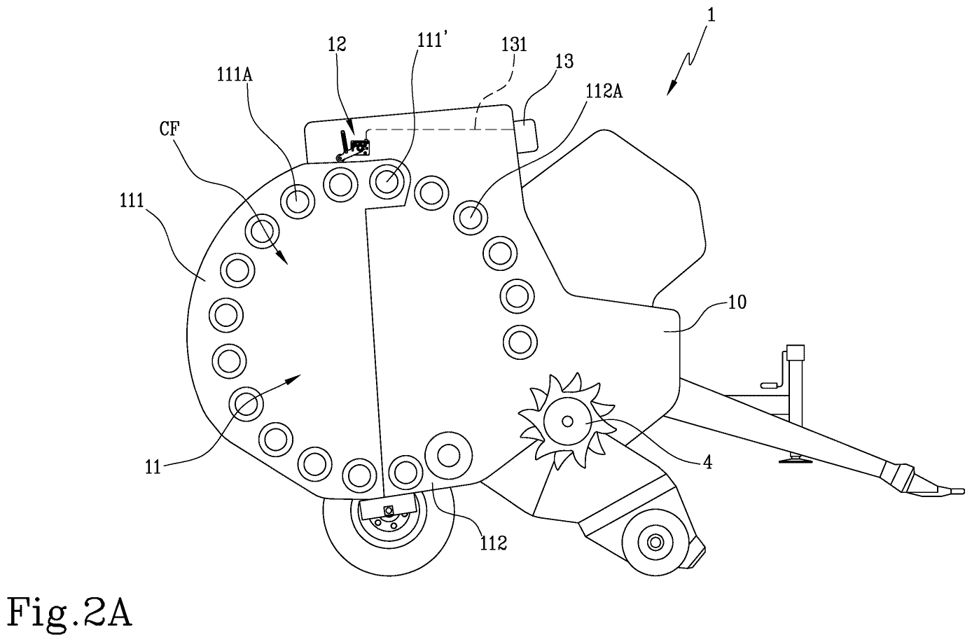

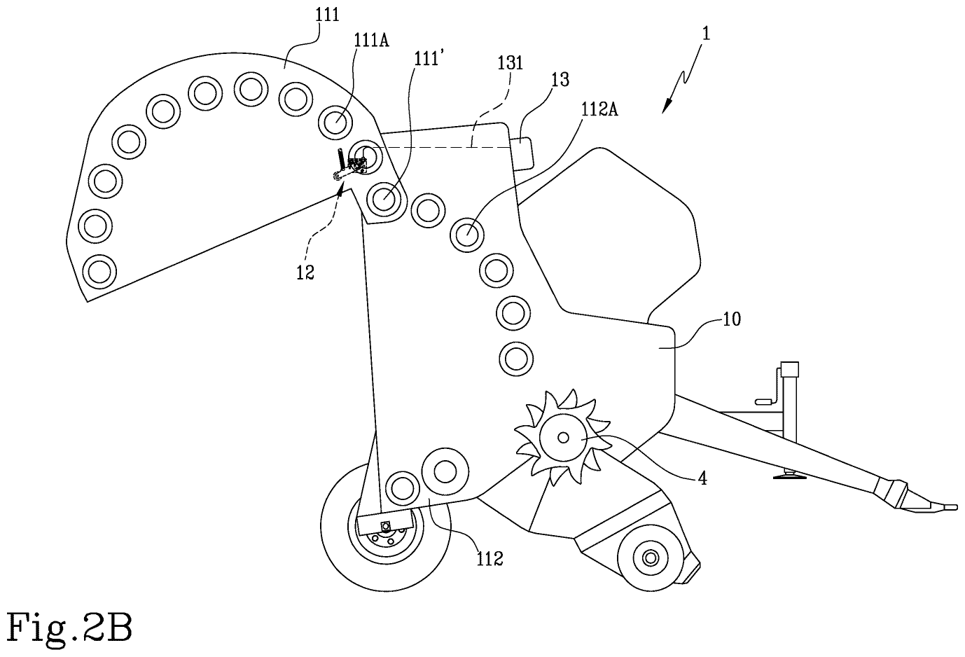

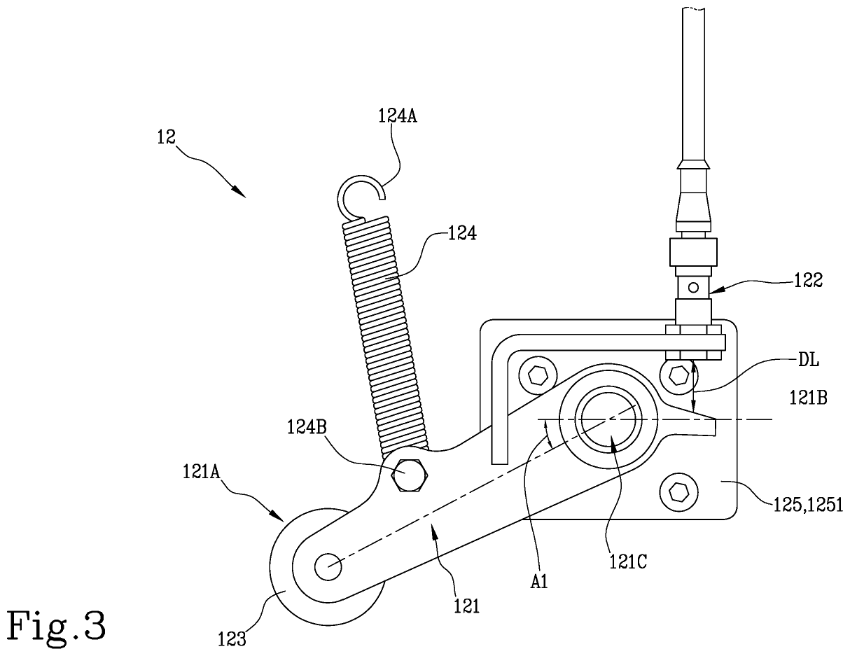

### DETAILED DESCRIPTION OF PREFERRED EMBODIMENTS OF THE INVENTION

With reference to the accompanying drawings, the numeral 1 denotes a round baler for making bales. The round baler 1 comprises a frame 10. The round baler 1 comprises a plurality of rolling elements, which allow its movement along the farmland.

The round baler 1 comprises a baling chamber 11, configured to allow a formation of the bale from crops which are picked up from the ground. There are two embodiments with reference to the baling chamber 11.

In particular, according to an embodiment, relating to classic round balers, there is a single baling chamber 11, the opening of which determines the release of the bale to the ground. The release of the bale to the ground is determined by the reaching, by the bale, of a predetermined density.

On the other hand, according to a further embodiment, the round baler comprises a first baling chamber 11 (which defines the above-mentioned baling chamber 11) and a second baling chamber 11′. This embodiment, commonly known in the trade with the term non-stop baler, is a round baler wherein the first baling chamber 11 allows a bale to be made with a predetermined density, upon reaching which the bale is transferred to the second baling chamber 11′, in which the bale is completed and then discharged to the ground.

For this reason, in both solutions, it is very important to determine the density of the bale.

The round baler 1 comprises a feed device 4, configured for conveying the crops in the baling chamber 11. If the round baler also comprises the second baling chamber 11′, the feed device 4 comprises a diverter 141, which allows the crops to be directed in the first baling chamber 11 or in the second baling chamber 11′.

The baling chamber 11 comprises a first shell 111. The baling chamber comprises a second shell 112.

The round baler comprises a first plurality of rollers 111A. The round baler comprises a second plurality of rollers 112A. The first plurality of rollers 111A is associated with the first shell 111. The second plurality of rollers 112A is associated with the second shell. In this way, the rollers of said first and second plurality 111A and 112A are able to move the crops inside the baling chamber 11 and, therefore, form the bale.

In other words, the round baler is a round baler with a fixed baling chamber 11. In the case of a round baler with two baling chambers 11, 11′, both the baling chambers are fixed baling chambers.

The baling chamber 11 is movable between a forming configuration CF, wherein the first shell 111 and the second shell 112 are closed to each other to define a fixed inner space VI in which the crops are fed, and a releasing configuration CR, wherein the first shell 111 and the second shell 112 are spaced from each other to allow an escape of the bale from the baling chamber 11.

More specifically, if the baling chamber is of the traditional type with a single baling chamber 11, the first shell is defined by the first shell 111 of the baling chamber whilst the second shell is connected to the frame 10.

According to this embodiment, the first shell 111 (that is to say, the door 111) is movable by rotation relative to the frame 10 between an open position, wherein the bale may pass to be released to the ground, and a closed position, wherein the first shell is closed on the second shell 112 to allow the formation of the bale.

It should be noted that, in the closed position of the first shell 111, the latter in any case comprises a certain compliance, that is to say, it rotates about the hinge due to the effect of a thrust inside the baling chamber 11, which, presumably, is deriving from the pressure of the bale being formed (which, in turn, depends on the density of the bale). As a result, the density of the bale is proportional to the pressure exerted by the bale in the baling chamber 11 and, therefore, by detecting the compliance of the first shell 111 it is possible to estimate a density value of the bale in the baling chamber 11.

In the same way, if the round baler is of the non-stop baler type, the baling chamber 11 is defined by the first baling chamber 11 (that is, the pre-chamber). In that case, the first shell 111 is the lower shell of the pre-chamber 11, which rotates about a first hinge 111′ between an operating position, wherein the bale is formed in the pre-chamber 11, and a tipping position, in which it conveys the pre-formed bale in the second baling chamber 11′.

The second shell 112 is the upper shell of the baling chamber 11. In this case, the second shell 112 also rotates about a second hinge 112′, also between a respective operating position, wherein it is closed on the first shell 111 to define the inner space VI inside which the bale is being formed, and a respective tipping position, wherein it is raised relative to the first shell 111 to define an access to the second baling chamber 11′, to allow the tipping of the bale inside it.

In this case, both the first shell 111 and the second shell 112 may yield in the respective operating positions, in such a way that they perform a small rotation due to the pressure of the bale which is being formed inside it. However, it is preferable that the first shell 111 is the one which is compliant in its operating position since its compliance, even due to the effect of the weight of the bale, is greater and, therefore, allows a more reliable detection of the density of the bale to be achieved. In effect, also in this case, the density of the bale is proportional to the pressure exerted by the bale in the baling chamber 11 and, therefore, by detecting the compliance of the first shell 111 (or of the second shell 112) it is possible to estimate a density value of the bale in the pre-chamber 11.

For moving the first shell 111 and/or the second shell 112, the round baler comprises a releasing actuator, configured for switching the baling chamber between the forming configuration CF and the releasing configuration CR.

Moreover, the round baler comprises a control unit 13, configured for instructing the releasing actuator when switching the baling chamber 11, that is, for moving the first shell 111 and/or the second shell 112.

As described above, the control unit 13 is programmed for switching the baling chamber 11 as a function of the density value of the bale being formed, in such a way that, once a certain density value is reached, the bale is released (single chamber) or transferred (non-stop baler).

In this regard, therefore, the round baler comprises a detecting unit 12. The detecting unit 12 is configured for detecting the density of the bale in the baling chamber 11, whether it is the pre-chamber or the single baling chamber.

The detecting unit 12 is configured to detect the density of the bale in the baling chamber 11 detecting the compliance of the first shell 111 and/or of the second shell 112, preferably the compliance of the first shell 111.

The detecting unit 12 is configured for detecting a thrust signal 131, representing a pressure of the bale in the baling chamber 11. The detecting unit 12 is configured for sending the thrust signal to the control unit.

As mentioned, the control unit 13 is configured to instruct the releasing actuator to switch the baling chamber 11 to the releasing configuration CR on the basis of the thrust signal 131.

The detecting unit 12 is configured to detect the density of the bale in the baling chamber 11 detecting the rotation of a member (contact element) which rotates, as a result of a rotation of the first shell 111 and/or of the second shell 112.

More specifically, the detecting unit 12 comprises a contact element 121. The contact element 121 is preferably rigid. The contact element 121 comprises a contact end 121A, which maintains the continuous contact with the first shell 111 or with the second shell 112 in the forming configuration CR of the baling chamber 11, that is, in the operating position of the first shell 111 and/or in the operating position of the second shell 112, respectively.

The contact element 121 is connected to the frame at a detection hinge 121C, to rotate relative to the frame 10 in response to a movement of the first shell 111 and/or of the second shell 112. In other words, the rotation of the first shell 111 and/or of the second shell 112 due to the effect of the pressure of the bale about the first hinge 111′ or the second hinge 112′, respectively, determines a force having a component perpendicular to the contact element 121 which, being connected to the frame by means of the detecting hinge 121C, rotates.

The detecting unit 12 comprises a sensor 122. The sensor 122 is configured for detecting the thrust signal 131. The thrust signal represents an angular position A1 of the contact element 121. In effect, the angular position A1 of the contact element 121 is correlated with the compliance of the first shell 111 and/or of the second shell and, therefore, with the density of the bale.

According to a preferred embodiment, the contact element 121 comprises a detection portion 121B, on which the sensor 122 detects a parameter representing the angular position A1 of the contact element 121.

The detection portion 121B, according to a preferred embodiment, is positioned at the end opposite the contact end 121A, on the opposite side relative to the detection hinge 121C. The distance between the detection portion 121B and the detection hinge 121C is less than the distance between the contact end 121A and the detection hinge 121C.

In other words, the contact element 121 is a bar hinged in the detection hinge 121C wherein a first end is in contact with the first shell 111 and/or the second shell 112 whilst the second end is exposed to the sensor 122 for detecting a specific parameter (for example, the distance).

According to this embodiment, the sensor 122 is a distance sensor 122 which detects an operating distance DL, that is, a distance of the sensor from the detection portion 121B of the contact element 121. In effect, said distance is proportional to the angular position A1 of the contact element 121. Thus, with the variation in distance, the density value of the bale also varies. More specifically, as the distance decreases, the density of the bale is greater.

Other embodiments comprise the use of a force sensor (that is, a dynamometer), configured to determine a pulling force. Said force sensor is a sensor connected to the frame and to the detection portion 121B of the contact element 121, in such a way that a rotation of the contact element 121 determines a variation of pulling on the sensor, since the detection portion 121B moves away from or towards the point wherein the sensor is connected to the frame 10.

Lastly, according to a further embodiment, it is possible to provide (as a sensor) an encoder 122 which detects, directly, the angular position A1 of the contact element 121.

The detecting unit 12 also comprises a rolling element 123, configured to rotate along a sliding surface of the first shell 111 and/or of the second shell 112 whilst the latter yields under the pressure of the bale. The rolling element 123 is a bearing connected to the contact end 121A of the contact element 121. This prevents jamming of the contact element which could adversely affect the measurement.

Moreover, in order to keep the contact with the first shell 111 and/or with the second shell 112 whilst the latter yields under the pressure of the bale, the detecting unit 12 comprises a contact spring 124, configured to apply a force, on the contact element 121, having a direction opposite to the force exerted by the movement of the first shell 111 and/or the second shell 112. The contact spring 124 comprises a first end 124A, connected to the frame, and a second end 124B, connected to the contact element 121. Preferably, the second end 124B is connected in a position of the contact element 121 interposed between the contact end 121A and the detection hinge 121C.

Regardless of the parameter detected by the sensor (distance, force and/or angular position), it is preferable that the sensor operates with a continuous detection of the parameter over time. This makes it possible to have a continuous control of the density value of the bale and/or the filling value of the baling chamber 11. In this way, the control unit 13 compares (in real time and/or continuously) the thrust signal 131 with a predetermined density value, greater than which the bale must be released and/or transferred.

This aspect is very important because it allows this control to be implemented on continuous and non-discrete values and therefore prevents the release from being started, for example, by a contact. A release by contact would in fact have several drawbacks: (i) wear of the contact with necessary recalibration; (ii) wear of the contact element which would be exposed to constraints which, on the contrary, in this case, it does not have.

Moreover, this system provides an excellent flexibility to be able to operate with various crops, the predetermined density of which is reached by rotations of the contact element 121 which are very different to each other and which, therefore, if a regular activation were operated it could not be controlled by the sensor.

In this regard, it should be noted that the round baler comprises a user interface for receiving (that is, accessing) configuration data, representing one or more of the following characteristics: a type of crop; a humidity value of the crop; a predetermined density value, after reaching which the control unit commands a switching of the baling chamber 11 to the releasing configuration CR; a predetermined threshold value, representing a value of the thrust signal after reaching which the control unit commands a switching of the baling chamber 11 to the releasing configuration CR.

The control unit is programmed to determine, on the basis of the thrust signal 131 and the configuration data, a predetermined value for the thrust signal at which to switch the baling chamber 11 to the releasing configuration CR. Thus, it is clear that the configuration data actively contribute to determining the rotation of the contact element 121 for which the density reaches the predetermined value (inserted by the operator or calculated by the control unit).

The detecting unit comprises a cover 125. The cover 125 comprises an opening, from which the contact element 121 passes. The cover has an internal space in which the sensor 122 and the detection portion 121B are at least contained. Preferably, the cover 125 also covers the detection hinge 121C. According to an embodiment, the cover 125 comprises a base 1251, connected to the frame 10 and on which the sensor 122 and the contact element 121 are connected (by means of the detection hinge 121C). The cover 125 comprises a lid, removably connected to the base 1251 for covering the detection hinge 121C, the sensor 122 and the detection portion 121B which are positioned on the base 1251 of the cover 125.

According to an aspect of the invention, the invention provides a method M for making a bale with the round baler 1 according to the invention.

The method comprises a step F1 of forming a bale from crops by means of a baling chamber 11 comprising a first shell 111 and a second shell 112.

The method comprises a step F2 for moving the crops in the baling chamber 11 by means of a first plurality of rollers 111A and a second plurality of rollers 112A associated with the first shell 111 and the second shell 112, respectively.

The method comprises a step F3 of switching the baling chamber between a forming configuration CF, wherein the first and the second shell 111, 112 are closed to each other to define a fixed inner space VI in which the crops are fed, and a releasing configuration CR, wherein the first and the second shell 111, 112 are spaced from each other to allow an escape of the bale from the baling chamber 11.

The method comprises a step F4 of moving the first and/or the second shell 111, 112, in the forming configuration CF of the baling chamber 11, by the effect of a thrust (that is, pressure) applied by the bale being formed in the baling chamber 11.

The method comprises a step F5 of detecting a thrust signal 131, representing a pressure of the bale in the baling chamber 11, by means of a detecting unit 12.

The method comprises a step F6 for sending the thrust signal 131 to a control unit 13.

The method comprises a step F7 for controlling a releasing actuator to switch the baling chamber 11 in the releasing configuration CR on the basis of the thrust signal 131, using the control unit 13.

According to an embodiment of the method, the detecting step F5 comprises a step F51 of rotation of a contact element 121 (preferably rigid) in response to a movement of the first shell or the second shell 111, 112. In the rotation step F51, a contact end 121A of the contact element 121 remains in contact with the first shell or the second shell 111, 112 during the movement (by compliance) of the first shell or of the second shell 111, 112 in the forming configuration CF of the baling chamber.

The detecting step F5 comprises an acquisition step F52, wherein a sensor 122 detects the thrust signal 131, representing an angular position of the contact element.

1. A round baler comprising:
a frame
a baling chamber, associated with the frame and configured for at least partly forming a bale from crops,
wherein the baling chamber comprises a first shell and a second shell and is movable between a bale forming configuration, in which the first and the second shell are positioned end to end to define a fixed internal space into which the crops are fed, and a releasing configuration, in which the first and the second shell are spaced apart to allow releasing the bale from the baling chamber,
wherein the first shell and/or the second shell, give way with respect to the frame under the thrust force exerted by the bale being formed when the baling chamber is in the bale forming configuration;
a first and a second plurality of rollers associated with the first and the second shell, respectively, to move the crops into the baling chamber to form the bale;
a releasing actuator, configured to switch the baling chamber between the bale forming configuration and the releasing configuration;
a control unit, configured to instruct the releasing actuator to switch the baling chamber;
a detecting unit, configured to detect a thrust signal, representing a pressure of the bale in the baling chamber and to send the thrust signal to the control unit, wherein the control unit is configured to instruct the releasing actuator to switch the baling chamber to the releasing configuration based on the thrust signal, wherein the detecting unit comprises:
a rigid contact element including a contact end which, when the baling chamber is in the baling configuration, is configured to remain in contact with the first shell or the second shell and rotatably connected to the frame to rotate in response to a movement of the first shell or of the second shell;
a sensor, configured to detect the thrust signal, which represents an angular position of the contact element.

2. The round baler according to claim 1, wherein the sensor is a distance sensor, configured to detect a working distance, representing a distance of the sensor from a detection portion of the contact element, wherein a rotation of the contact element causes a corresponding variation in the working distance.

3. The round baler according to claim 2, wherein the sensor comprises a hinge about which the contact element oscillates, wherein the detection portion is positioned, with respect to the hinge, at the end opposite the contact end to define a detection end of the contact element.

4. The round baler according to claim 3, wherein the distance between the contact end and the hinge is greater than the distance between the detection end and the hinge.

5. The round baler according to claim 2, wherein the detecting unit comprises a cover, including an opening through which the contact element passes, and wherein the detection portion and the sensor are covered by the cover.

6. The round baler according to claim 1, wherein the detecting unit comprises an elastic element, including a first end, connected to the frame, and a second end, connected to the contact element to apply a contact force on the contact element so as to keep the contact end in contact with the first and/or the second shell.

7. The round baler according to claim 1, wherein the detecting unit comprises a rolling element, positioned at the contact end and configured to roll along a running surface of the first and/or the second shell.

8. The round baler according to claim 1, comprising an additional baling chamber, defining a second baling chamber, wherein the baling chamber defines a first baling chamber, the second baling chamber being configured to receive the bale from the first baling chamber.

9. The round baler according to claim 8, wherein the second shell is movable about a second hinge to define an access to the second baling chamber from the first baling chamber, and wherein the first shell is movable about a first hinge to tip the bale from the first baling chamber to the second baling chamber through said access, the detecting unit being associated with the first shell of the first baling chamber.

10. The round baler according to claim 1, wherein the control unit is configured for:
accessing configuration data, representing one or more of the following characteristics:
a type of crop;
a crop moisture value;
a preset density value which, when reached, causes the control unit to switch the baling chamber to the releasing configuration;
a preset threshold value representing a value of the thrust signal which, when reached, causes the control unit to switch the baling chamber to the releasing configuration,
and wherein the control unit is programmed to switch the baling chamber-(11) to the releasing configuration on the basis of the configuration data.

11. The round baler according to claim 10, wherein the sensor is configured to detect the thrust signal continuously in order to derive a bale density value continuously, wherein the control unit is configured to switch the baling chamber to the releasing configuration when the bale density value is greater than or equal to a preset density value.

12. (canceled)

13. The round baler according to claim 1, further comprising a user interface including a display configured to show, in real time, a bale-density value derived by the control unit.

14. The round baler according to claim 13, wherein the user interface is further configured to receive settings data from the operator, representing a predetermined density value which the control unit must use to automatically determine when to release the bale.

15. The round baler according to claim 13, wherein the user interface is configured to receive configuration data, representing one or more of the following characteristics: a type of crop; a humidity value of the crop; a predetermined density value, after reaching which the control unit commands a switching of the baling chamber to the releasing configuration; a predetermined threshold value, representing a value of the thrust signal after reaching which the control unit commands a switching of the baling chamber to the releasing configuration.

16. The round baler according to claim 1, wherein the control unit is configured to selectively operate in an automatic mode or a manual mode, the automatic mode releasing the bale based on a threshold of thrust signal determined by the control unit and the manual mode allowing an operator to command release independently of the threshold.

17. The round baler according to claim 16, wherein in the automatic operating mode the control unit is configured to perform the following steps:
receiving and processing configuration data indicating the humidity value of the crop;
determining, on the basis of configuration data indicating the humidity value of the crop, a predetermined threshold value for the thrust signal, such that the density at which the baling chamber switches to the releasing configuration is equal to a predetermined average density value.

18. The round baler according to claim 16, wherein in the automatic operating mode the control unit is configured to perform the following steps:
receiving and processing configuration data indicating the humidity level of the crop and a predetermined density value set by the user;
determining, on the basis of the configuration data, a predetermined threshold value for the thrust signal, such that the density at which the baling chamber switches to the releasing configuration is equal to the predetermined density value entered by the user and such as to take into account the humidity level.

19. The round baler according to claim 16, wherein in the manual operating mode, the control unit is configured to perform the following steps:
receiving and processing a predetermined threshold value entered with configuration data;
switching, on the basis of the predetermined threshold value inserted, the baling chamber to the releasing configuration when the thrust signal reaches the predetermined threshold value.

20. The round baler according to claim 1, wherein the sensor is a load cell, for determining a force on a deformation element, which is proportional to the rotation of the contact element, or an angular sensor configured to detect an angular position of the contact element, which is correlated with density of the bale.

21. A method for making bales by means of a round baler, the method comprising the following steps:
forming a bale from crops through a baling chamber comprising a first shell and a second shell;
moving the crops into the baling chamber through a first and a second plurality of rollers associated with the first and the second shell, respectively;
switching the baling chamber between a bale forming configuration, in which the first and the second shell are positioned end to end to define a fixed internal space into which the crops are fed, and a releasing configuration, in which the first and the second shell are spaced apart to allow releasing the bale from the baling chamber,
moving the first shell and/or the second shell under the thrust force exerted by the bale being formed when the baling chamber is in the bale forming configuration;
detecting a thrust signal, representing a pressure of the bale in the baling chamber, via a detecting unit;
sending the thrust signal to a control unit,
instructing a releasing actuator to switch the baling chamber to the releasing configuration based on the thrust signal, via the control unit,
wherein the step of detecting comprises the following steps:
rotating a rigid contact element in response to a movement of the first shell or of the second shell, wherein the contact element includes a contact end, which remains in contact with the first shell or the second shell when the first shell or the second shell move while the baling chamber is in the baling configuration,
wherein the thrust signal is detected by a sensor of the detecting unit and represents an angular position of the contact element.
